(19) United States
(12) Patent Application Publication
(10) Pub. No.: US 2022/0233982 A1
(43) Pub. Date: Jul. 28, 2022

(54) AIR FILTERING ELEMENT

(71) Applicant: UFI INNOVATION CENTER S.R.L., Ala, Trento (IT)

(72) Inventor: Giorgio GIRONDI, Ala, Trento (IT)

(21) Appl. No.: 17/612,725

(22) PCT Filed: May 19, 2020
(86) PCT No.: PCT/IB2020/054735

§ 371 Date: Nov. 19, 2021

(30) Foreign Application Priority Data
May 22, 2019 (IT) 102019000007118

(51) Int. Cl. B01D 39/16

(52) U.S. Cl. CPC B01D 39/1623; B01D 2239/0442; B01D 2239/0407; B01D 2239/0421; B01D 2239/0654; B01D 2239/1233; B01D 2239/1241; B01D 2239/0618; B01D 2239/1208

(57) ABSTRACT

An air filtering element, for example of a ventilation system, such as an air ventilation system of a vehicle passenger compartment, includes a filtering medium (1). The filtering medium (1) has a main layer (10) of non-woven fabric including synthetic base fibers (110) and antimicrobial agents (120) in metal or in a metal compound and/or based on a metal complex and/or based on a metal salt. The main layer (10) of non-woven fabric has a porosity value of between 80% and 95%, preferably between 85% and 95%, preferably between 85% and 93%. In addition, the main layer (10) has hydrophilic behavior, so as to collect and form aggregates of water on which the antimicrobial agents (120) act and perform their antimicrobial action.

### FIELD OF APPLICATION

The present invention relates to an air filtering element and an air ventilation system of a vehicle passenger compartment comprising said air filtering element.

The context in which the present invention lies is the automotive sector. In particular, the present invention relates specifically to air that is ventilated in the passenger compartment of a vehicle.

### STATE OF THE ART

In the state of the art, solutions are known for passenger compartment air ventilation systems suitable for conveying, typically by suction, air from the external environment into the passenger compartment of a vehicle. Such systems typically comprise at least one air filtering element suitable, by means of suitable filtering media included therein, to filter external air to prevent unwanted elements from entering the passenger compartment.

Filtering media solutions suitable for particulate filtration of solid contaminants, such as dust or dirt, in other words, fine dust, pollen and pollutant particles, are known of.

Filtering media solutions suitable to prevent microbes or bacteria from reaching the vehicle passenger compartment are also known of. In these filtering media solutions, in fact, the presence of special antibacterial agents is envisaged to prevent the microbes reaching the filtering medium or forming in the filtering medium from reaching the passenger compartment.

Filtering media solutions suitable for odour absorption actions are also known of.

In the state of the art, filtering media having different properties or filtering media (e.g., multilayer) combining multiple properties are known of. In order to reduce the space occupied in the vehicle, the latter have become particularly widespread.

Such multi-layer medium solutions, however, are complex and costly to implement, especially in those embodiments in which maximum efficiency of each layer is sought. In addition, the greater the number of layers, the greater the overall dimensions of the filtering medium and therefore of the air filtering element.

### Solution According to the Invention

The need is therefore strongly felt to have an air filtering element that solves the aforementioned problems encountered in state-of-the-art solutions, i.e. an air filtering element that has strong filtering characteristics with as simple and small a structure as possible.

The object of the present invention is, therefore, to provide an air filtering element that meets this need.

Such purpose is achieved by an air filtering element as claimed in claim 1 and by a vehicle passenger compartment air ventilation system comprising said air filtering element according to claim 13. The claims dependent on these show preferred embodiments involving further advantageous aspects.

### DESCRIPTION OF THE DRAWINGS

Further characteristics and advantages of the invention will, in any case, be evident from the description given below of its preferred embodiments, made by way of a non-limiting example with reference to the appended drawings, wherein:

FIGS. 1 and 1a show respectively a schematic cross-section view and an enlargement thereof of a portion of a filtering medium comprised in an air filtering element according to a preferred embodiment of the invention;

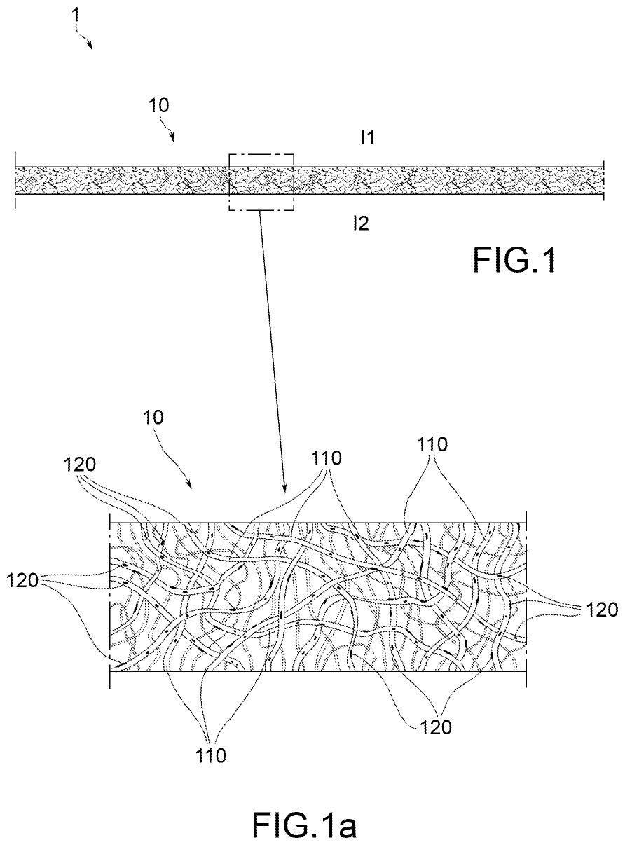

FIGS. 2 and 2a respectively show a schematic cross-section view and an enlargement thereof of a portion of a filtering medium comprised in an air filtering element according to a further preferred embodiment of the invention;

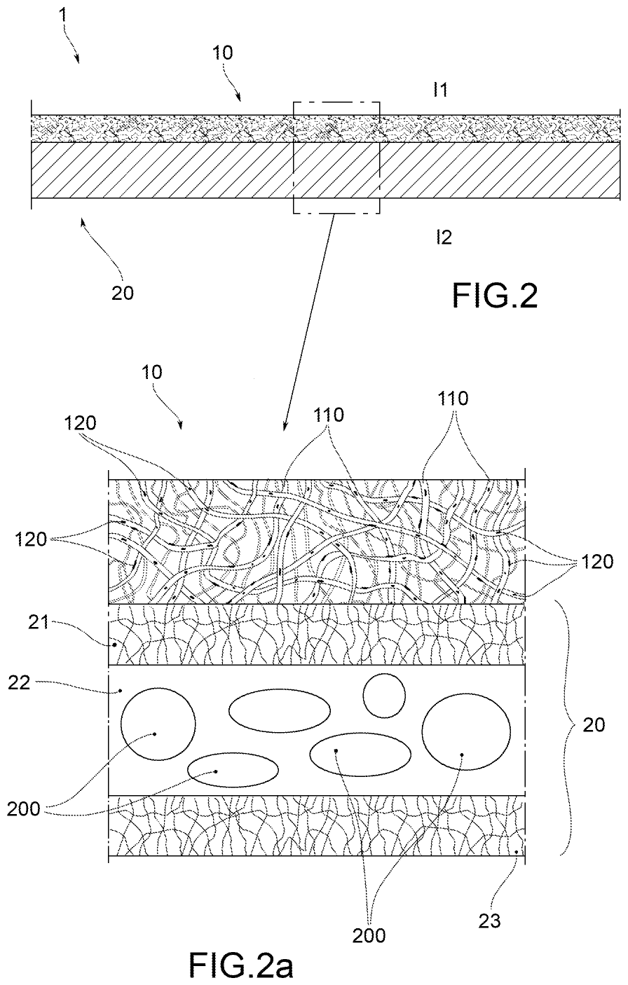

FIG. 3 is a photo taken by an electron microscope of a portion of a filtering medium included in an air filtering element according to the present invention.

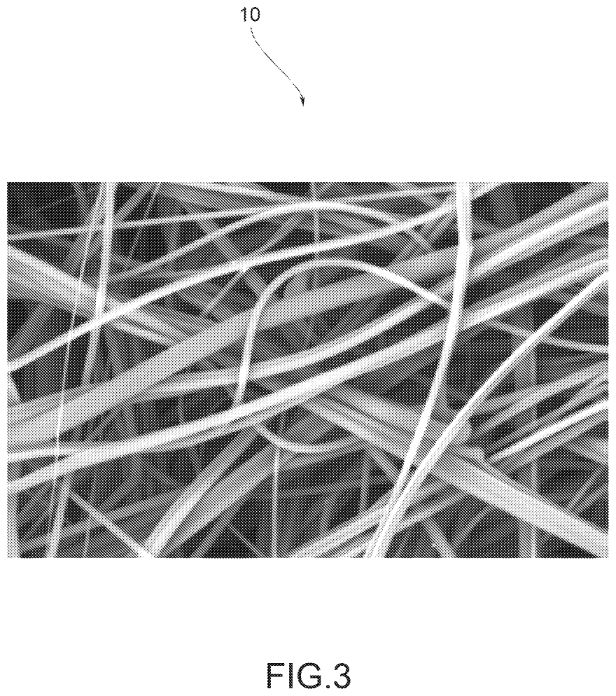

### DETAILED DESCRIPTION

With reference to the appended drawings, reference numeral 1 denotes a filtering medium comprised in an air filtering element according to the present invention.

The object of the present invention is, in fact, an air filtering element, for example of a ventilation system, preferably of a vehicle air ventilation system.

Such air filtering element comprises a filtering medium 1 suitable for performing a particulate filtration action on the air passing through it. In other words, the filtering medium 1 performs a particulate filtration of solid contaminants, such as dust or dirt, i.e. fine dust, pollen and pollutant particles.

In addition, such air filtering element comprises a filtering medium 1 suitable to exert an antimicrobial action, i.e. an action to reduce the microbial and/or bacterial load that forms on the filtering medium 1. In other words, the filtering medium reduces the microbes and/or bacteria that reach the filtering medium or that form on (or in) the filtering medium.

In other words, according to the present invention, the filtering medium 1 is suitable for performing said dual function.

Accordingly, the filtering medium 1 is such as to have a dirty side Il and a clean side 12: in the first side the air to be filtered flows, in the second side filtered air flows.

According to a preferred embodiment, the filtering medium 1 comprises a main layer 10.

Preferably, the main layer 10 alone is already suitable to perform said dual function of the filtering medium 1.

According to the present invention, the main layer 10 is made of non-woven fabric.

According to the present invention, the main layer 10 comprises synthetic base fibres 110 and antimicrobial agents 120.

In other words, according to the present invention, the main layer 10 is in a non-woven fibre fabric.

According to the present invention, the main layer 10 is in a non-woven fabric of synthetic base fibres 110 comprising an antimicrobial agent 120. In other words, according to the present invention, the main layer 10 is made of non-woven fabric of synthetic base fibres 110 with antimicrobial agent 120 integrated therein.

According to a preferred embodiment, the synthetic base fibres 110 have an average diameter of between 5 and 15 μm.

According to a preferred embodiment, the synthetic base fibres 110 are made of polypropylene (PP) or polyethylene terephthalate (PET) or polybutylene terephthalate (PBT) or polyamide (PA) and/or a mixture thereof.

According to a preferred embodiment, the synthetic base fibres 110 are single-component fibres and/or dual-component fibres.

According to the present invention, in addition, said antimicrobial agents 120 are made of metal or a metal compound and/or based on a metal complex and/or based on a metal salt.

Preferably, the antimicrobial agents 120 have an average diameter between 1 and 10 μm.

Preferably, then, the antimicrobial agents 120 are retained by the synthetic base fibres 110.

Preferably, the antimicrobial agents 120 are embedded (i.e., integrated) within the synthetic base fibres 110. Preferably, therefore, the antimicrobial agents 120 are embedded in the synthetic base fibres 110. Preferably, therefore, the antimicrobial agents 120 are at least in part surrounded by the material of which the synthetic base fibres 110 are made.

According to a preferred embodiment, the antimicrobial agents 120 are in silver, preferably in the form of silver ions, Ag +.

According to the present invention, the main layer 10 in non-woven fabric has a porosity value of between 80% and 95%, preferably between 85% and 95%, preferably between 85% and 93%. Where porosity means the ratio of the total volume of all the pores present in the main layer 10 to the volume of the main layer 10 in its entirety. Preferably, therefore, the main layer 10 is highly permeable.

According to the present invention, the main layer 10 has hydrophilic behaviour such as to collect and form aggregates of water, on which the antimicrobial agents act and perform their antimicrobial action. In other words, the main layer 10 has hydrophilic behaviour so as to collect and distribute water on the surface of the non-woven fabric fibres so that the antimicrobial agents 120, present therein, perform their antimicrobial action. In other words, the main layer 10 has hydrophilic behaviour such that any water/moisture/vapour particles carried in the circulating air stream in the ventilation system are collected by said main layer 10 distributing themselves on the surface of the synthetic base fibres 110 wherein in said collected or intercepted water the antimicrobial agents 120 perform their antimicrobial action.

Specifically, in fact, the main layer 10 in non-woven fabric is functionalized to have hydrophilic behaviour.

Preferably, the synthetic base fibres 110 are functionalized to have hydrophilic behaviour. In other words, the main layer 10, in particular, the non-woven fabric, is subject to specific functionalization treatments that thus enable its hydrophilic behaviour.

Preferably, the antimicrobial agents 120 are also treated in turn to have hydrophilic behaviour.

Preferably, the antimicrobial agents 120 are integrated into the functionalized portions of the synthetic base fibres 110 having hydrophilic behaviour.

In other words, the non-woven fabric (comprising the base fibres 110 and the antimicrobial agents 120) is treated by functionalizing additives so as to have said hydrophilic behaviour.

Preferably, the main layer 10 is suitable for being impregnated with water. Preferably, the main layer 10 is suitable for intercepting water/humidity/vapour particles dispersed in the circulating air in the aeration circuit so as to collect and distribute the water on the surface of the base fibres 110 on which the anti-microbial agents 120 perform their antimicrobial action.

Thus, in other words, the main layer 10 exhibits a tendency to wet itself with water and to favour the penetration of water in the porosities present in the non-woven fabric.

According to a preferred embodiment, in the production operations of the main layer 10 the polymer granules with which the synthetic fibres are produced, the antimicrobial agents and the functionalizing additives are mixed in the same hopper and with the compound thus obtained the non-woven fabric is produced and thus said main layer 10.

Preferably, the filtering medium 1 is produced by a melt-blown process.

According to a preferred embodiment, the elements constituting the main layer 10 are arranged entirely randomly along its length and along its thickness.

According to a preferred embodiment, the main layer 10 has a static water contact angle of less than 90°.

According to a preferred embodiment, the main layer 10 is between 0.5 and 2 mm thick.

In addition, preferably, the main layer 10 has an average pore diameter between 20 and 40 μm, preferably between 25 and 35 μm.

According to a preferred embodiment, the main layer 10 is suitable for filtering particles greater than or equal to 2.5 μm without compromising the pressure drop of the system.

According to a preferred embodiment, the antimicrobial agent is present in a percentage less than 1% of the total weight of the main layer 10; preferably the antimicrobial agent is present in a percentage ranging from 0.005% to 0.025% of the total weight of the main layer 10.

According to a preferred embodiment, the filtering medium 1 of the air filtering element comprises only the main layer 10 described above.

According to other embodiments, the filtering medium 1 is a multilayer and comprises in addition to the main layer 10 at least one secondary layer 20.

Preferably, the main layer 10 is positioned upstream of the secondary layer 20 relative to the direction of air circulation.

Preferably, the main layer 10 faces the dirty side I1 so that it is the first layer of the filtering medium 1 that encounters the air.

According to a preferred embodiment, the secondary layer 20 is suitable for performing an adsorbent action on gases dispersed in the air through the filtering medium 1. In particular, the secondary layer 20 comprises adsorbent elements, preferably comprising activated carbons 200.

In other words, the secondary layer 20 is suitable for performing an adsorbent action against gas molecules present in the circulating air stream in the ventilation system.

Preferably, the secondary layer 20 in turn has a multi-layer structure comprising two support layers 21, 23 and an adsorbent central layer 22.

Preferably, the two support layers 21, 23 are made of non-woven fabric composed of synthetic fibres.

Preferably, the adsorbent central layer 22 comprises said activated carbon adsorbent elements 200.

According to a preferred embodiment, the filtering medium 1 is in the form of a panel defining the dirty side Il and the clean side 12 on the two opposite faces (being traversable by air in a transverse direction); preferably the filtering medium 1 is of the pleated type.

According to a further embodiment, the filtering medium 1 is in tubular form defining the dirty side Il and the clean side 12 on the inside and outside thereof or vice versa (being traversable by air in the radial direction); preferably the filtering medium 1 is of the pleated type, i.e., the filtering medium 1 is of the star type.

Furthermore, as mentioned, the invention also relates to a vehicle passenger compartment air ventilation system comprising an air filtering element according to the above description.

Innovatively, the air filtering element and the passenger compartment air ventilation system of a vehicle comprising it according to the present invention amply fulfil the above-mentioned purpose by overcoming the problems typical of the prior art.

Advantageously, the filtering element has a simplified and inexpensive shape.

Advantageously, the filtering element is suitable for performing the desired (multiple) actions on the intake air. Advantageously, the main layer performs both solid filtration and an anti-microbial action. That is, advantageously, the filtering element is suitable for performing particulate filtration while reducing the microbial charge.

Advantageously, both particulate filtration and the reduction of microbial/bacterial load are obtained extremely effectively.

Advantageously, the highly permeable structure of the main layer formed by the weaving of synthetic fibres functionalized in such a way as to have hydrophilic behaviour and comprising the antimicrobial agent makes it possible to synergistically combine the effect of fine filtration of solid particles with an effective reduction of the bacterial load.

Advantageously, the use of an antimicrobial active ingredient incorporated in synthetic fibres makes it possible to avoid the unwanted release of antimicrobial agents into the environment and/or inside the passenger compartment.

Advantageously, the incorporation of an antimicrobial agent inside the fibres allows the active ingredient to be kept near the surface of the fibre where the bacteria are located, maximizing the benefit conferred by the presence of a film of water on said fibre and thus the benefit given by the interaction between hydrophilic functionalization and antimicrobial capacity.

Advantageously, the integration of the active ingredient inside the fibres allows the duration of the antimicrobial properties to be prolonged up to 10 years, much longer than the solutions in which the antibacterial ingredient is applied as a coating or as a coating on the filtering material that makes up the filtering element.

Advantageously, the synergistic effect of the hydrophilic action results in an improvement of the antimicrobial properties. Advantageously, compared to the same main layer without hydrophilic functionalization, the main layer of the present invention entails an increase to the order of 20% in the reduction of the bacterial load in the air.

Advantageously, the antibacterial action of the antimicrobial agents included in the main layer is more effective in that the presence of water promotes the migration of bacteria onto the surface of the fibres where they are subsequently effectively attacked by the antimicrobial agents.

Advantageously, the hydrophilic functionalization of the synthetic fibres that make up the non-woven fabric allows the antimicrobial treatment to be extended in the main layer practically in its entirety, i.e. in its thickness, and surface extension, maximizing the filtering element's reduction capacity both on the outer surface and inside the porosities of the filtering medium and in general in the portions of the filtering medium in which the formation of bacteria and microbes is favoured.

Advantageously, the filtering medium can be designed as a multi-layer.

Advantageously, in the embodiment of a multilayer filtering medium comprising an adsorbent secondary layer combined with the main layer an increase in particle efficiency has been found.

It is clear that a person skilled in the art may make modifications to the air filtering element and to the air ventilation system for the passenger compartment of a vehicle described above so as to satisfy contingent requirements, all contained within the scope of protection as defined by the following claims.

### LIST OF REFERENCE NUMBERS

1 Air filtering element
10 main body
110 synthetic base fibres
120 antimicrobial agents
20 secondary layer
21 support layer
22 central adsorbent layer
23 support layer
200 activated carbon elements
I1 clean side
I2 dirty side

1. An air filtering element, for an aeration system, of a vehicle interior air ventilation system, comprising a filtering media for performing a particulate filtering action on air that passes through the filtering media to identify a dirty side and a clean side, wherein the filtering media comprises a main layer of non-woven fabric comprising basic synthetic fibers and antimicrobial agents, of metal or of a metal compound and/or based on a metal complex and/or based on a metal salt;
wherein the main layer of non-woven fabric has a porosity value of between 80% and 95%;
wherein the main layer has hydrophilic behavior, so as to collect and form water aggregates on which the antimicrobial agents act and perform antimicrobial action.

2. An air filtering element according to claim 1, wherein the main layer has a static contact angle to water of less than 90°.

3. An air filtering element according to claim 1, wherein the antimicrobial agents are silver.

4. An air filtering element according to claim 1, wherein the antimicrobial agents have an average diameter of between 1 and 10 μm.

5. An air filtering element according to claim 1, wherein the antimicrobial agents are incorporated in the basic synthetic fibers.

6. An air filtering element according to claim 1, wherein the basic synthetic fibers have an average diameter of between 5 μm and 15 μm.

7. An air filtering element according to claim 1, wherein the basic synthetic fibers are made of functionalized polypropylene having a hydrophilic behavior.

8. An air filtering element according to claim 1, wherein the filtering media is a multilayer comprising in addition to the main layer at least one secondary layer, wherein the main layer is positioned upstream of the secondary layer with respect to a direction of air circulation.

9. An air filtering element according to claim 8, wherein said secondary layer is configured for carrying out an adsorbing action comprising active carbons.

10. An air filtering element according to claim 9, wherein said secondary layer has a multilayer structure comprising two support layers made of non-woven fabric composed of synthetic fibers and an adsorbing central layer comprising elements with said activated carbons.

11. An air filtering element according to claim 1, wherein the filtering media comprises a panel defining the dirty side and the clean side on two opposite faces.

12. An air filtering element according to claim 1, wherein the filtering media is tubular in shape defining the dirty side and the clean side inside and outside thereof or vice versa.

13. Vehicle interior air ventilation system comprising an air filtering element according to claim 1.

14. An air filtering element according to claim 1, wherein the main layer of non-woven fabric has a porosity value of between 85% and 95%.

15. An air filtering element according to claim 1, wherein the main layer of non-woven fabric has a porosity value of between 85% and 93%.

16. An air filtering element according to claim 1, wherein the antimicrobial agents are in the form of silver ions, Ag+.

17. An air filtering element according to claim 1, wherein the filtering media comprises a panel defining the dirty side and the clean side on two opposite faces, and wherein the filtering media is pleated.

18. An air filtering element according to claim 1, wherein the filtering media is tubular in shape defining the dirty side and the clean side inside and outside thereof or vice versa, and wherein the filtering media is pleated.
